(19) United States
(12) Patent Application Publication
(10) Pub. No.: US 2009/0056664 A1
(43) Pub. Date: Mar. 5, 2009

(54) Multiple carburetor intake manifold with an air exchange passageway and method

(76) Inventors: Jake Netser, Coral Harbour (CA); Eric Anderson, Enumclaw, WA (US)

Correspondence Address: DEAN A. CRAINE, SUITE 140, 400-112TH AVENUE NE, BELLEVUE, WA, 98004, US

(21) Appl. No.: 12/074,400

(22) Filed: Mar. 3, 2008

Related U.S. Application Data
(60) Provisional application No. 60/904,567, filed on Mar. 1, 2007.

(51) Int. Cl. F02M 35/104

(52) U.S. Cl. 123/184.21; 123/336

(57) ABSTRACT

A multiple carburetor two-stroke, two cylinder intake manifold that includes at least two cylinder bores evenly spaced apart on a flat, rectangular plate body. Formed in the plate body is a longitudinally aligned closed air passageway that extends between the two adjacent cylinders that allows the cylinders to draw air and gasoline mixture from any carburetor. In the first embodiment, the manifold includes an upper plate and a lower plate. The lower plate includes two oblong cylinder bores and a longitudinal aligned recessed cavity that acts as the air passageway when the upper plate is attached over the lower plate. In a second embodiment, the lower plate includes two circular cylinder bores and two adjacent slots formed at the opposite ends of a recessed cavity. A small cap is placed over the recessed cavity to form the air passageway. As disclosed herein is a method for improving the performance of a two stroke, two cylinder engine using one of the above referenced manifolds.

### BACKGROUND OF THE INVENTION

This is a utility patent application which claims benefit of U.S. Provisional Application No. 60/904,567 filed on March 1, 2007.

1. Field of the Invention

This invention pertains to intake manifolds, and more particularly to intake manifolds used with multi-carbureted, two stroke engines.

2. Description of the Related Art

Two-stroke engines are commonly used in chain saws, jet skis and snowmobiles. The main advantages of two-stoke engines over four-stroke engines is that they are lighter and provide more power because they fire every revolution rather than once every other revolution as four-stroke engines do.

Because two stroke engines do not have valves, two stroke engines are mechanically much simpler than four-stroke engines. The intake manifolds used on two stroke engines must include an intake port and exhaust port that allows the cylinders to draw the fresh air and gasoline mixture to the cylinder and to force the exhaust gas from the cylinders, respectively.

Snowmobiles typically use multi-carbureted two-stroke engines for greater power. Typically, the engines include a single intake manifold that with two carburetor throats formed thereon that connect to two carburetors. One problem using a single intake manifold with multiple carburetors is that flow of the fresh air and gasoline mixture from the two carburetors to the two cylinders may not be equal. The unequal flow of the fresh air and gasoline mixture to the two carburetors results in the outputs of the cylinders being imbalanced which results in lower engine performance.

What is needed is an improved multiple carburetor, two-stroke intake manifold that provides a more equal flow of fresh air and gasoline mixture to the carburetors attached to the manifold so that engine performance is improved.

### SUMMARY OF THE INVENTION

The above stated objective is met by the multiple carburetor two-stroke intake manifold disclosed herein that includes a longitudinally aligned air passageway that extends between multiple cylinder openings. In the first embodiment, the intake manifold includes a plate body made up of a vertically stacked and aligned upper plate and a lower plate. Formed on the upper plate are two carburetor rest platforms each with a large central bore and two outer threaded bores formed on opposite sides thereof. A standard two stroke carburetor is attached to each rest platform using threaded bolts. Formed around the upper plate is a plurality of ears with smooth holes formed therein. Threaded bolts extend through the ears to hold the two plate body on the engine block.

The lower plate is complimentary in shape with the upper plate with two oblong cylinder bores formed on its opposite ends. When properly installed the cylinder bores ae aligned and registered with two adjacent cylinders on the engine. The area of the top surface of the lower plate that extends between the two cylinder bores is recessed. When the upper plate is stacked above the lower plate a cross flow air passageway is formed between the two cylinder bores.

In a second embodiment, the plate body is a single elongated plate with a that fits over the center area of the plate. The plate that includes two carburetor rests each with a cylinder bore formed therein. Formed on the bottom surface of plate and around each cylinder bore is an elongated recessed opening. Formed in the plate are two secondary ports that extend downward through the plate and communication with the lower recessed opening. In the preferred embodiment, the secondary ports are elongated, transversely aligned slots. During assembly, an removable cap with a raise cavity formed therein is s attached over the top surface of the plate and between the two secondary ports which forms a cross flow air passageway between the two cylinder bores.

Using one of the two above described manifolds a method for improving the performance of a two stroke, side-by-side, two cylinder engine is provided.

### DESCRIPTION OF THE DRAWINGS

FIG. 1 is a perspective view of the first embodiment of the intake manifold with a cross flow air exchange passageway formed between the adjacent cylinder bores.

FIG. 2 is a top plan view of the first embodiment of the intake manifold shown in FIG.

FIG. 3 is a side elevational view of the first embodiment.

FIG. 4 is a sectional side elevational view of the first embodiment taken along line 4-4 in FIG. 2.

FIG. 5 is a bottom plan view of the first embodiment.

FIG. 6 is a side elevational view of the invention of the lower plate used with the first embodiment.

FIG. 7 is a sectional end elevational view of the first embodiment of the invention taken along line 7-7 in FIG. 3.

FIG. 8 is a sectional end elevational view of the first embodiment of the intake manifoldtaken along line 8-8 in FIG. 2.

FIG. 9 is a perspective view of the second embodiment of the intake manifold with a cross flow air exchange passageway formed between the adjacent cylinder bores.

FIG. 10 is a top plan view of the second embodiment of the invention.

FIG. 11 is a top plan view of the second embodiment of the invention with the cap removed.

FIG. 12 is a bottom plan view of the second embodiment.

FIG. 13 is a side elevational view of the second embodiment.

FIG. 14 is a sectional, side elevational view taken along line 14-14 in FIG. 10.

FIG. 15 is a sectional, side elevational view taken along line 15-15 in FIG. 13.

FIG. 16 is a sectional, side elevational view of the second embodiment taken along line 16-16 in FIG. 12.

FIG. 17 is a perspective view of the upper cap.

### DESCRIPTION OF THE PREFERRED EMBODIMENT(S)

Referring to the Figs, there is shown first and second embodiments of an intake manifold, generally indicated by the reference numbers 10, 50, respectively, designed for a two cylinder, two-stroke engine. Each intake manifold 10, 50, includes a longitudinally aligned cross flow air passageway 36, 66, respectively, that extends between the two cylinder bores 16, 22 and 56, 62, respectively, formed on opposite sides of the manifold, thereby enabling the fresh air and gasoline mixtures between two adjacent carburetors (not shown) to be more equally distributed between the two carburetors and between the two cylinders.

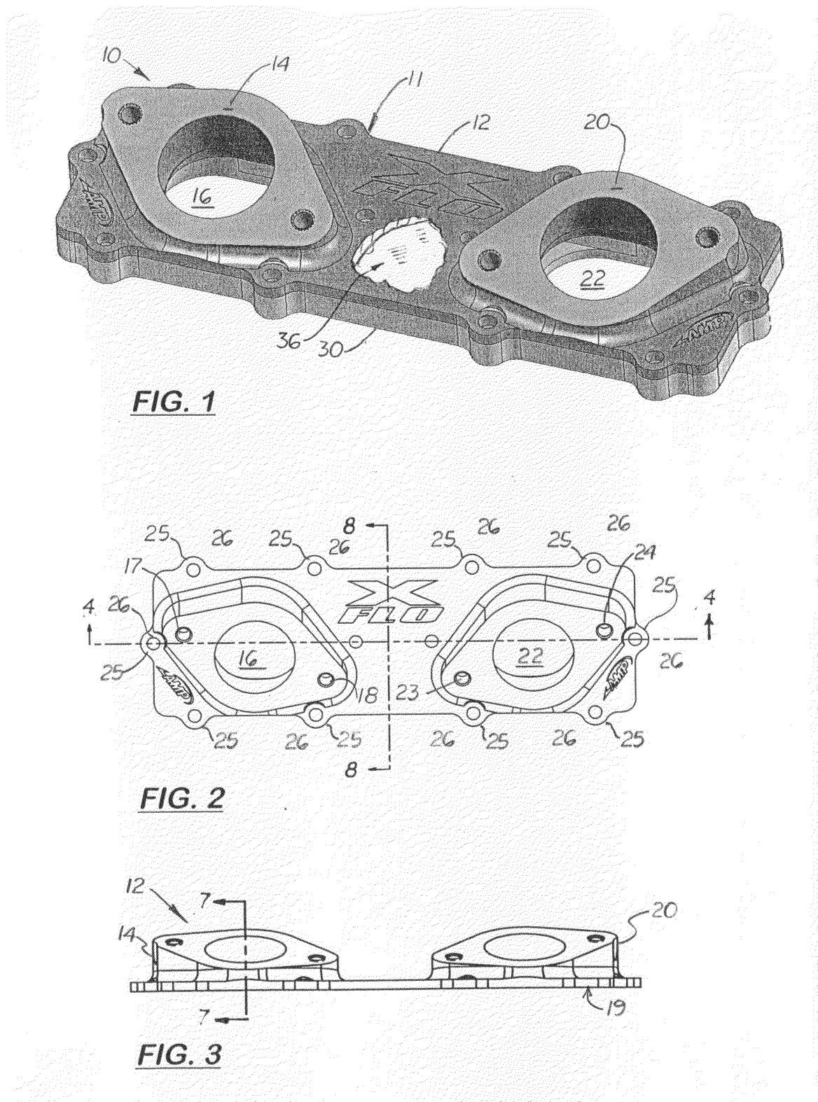

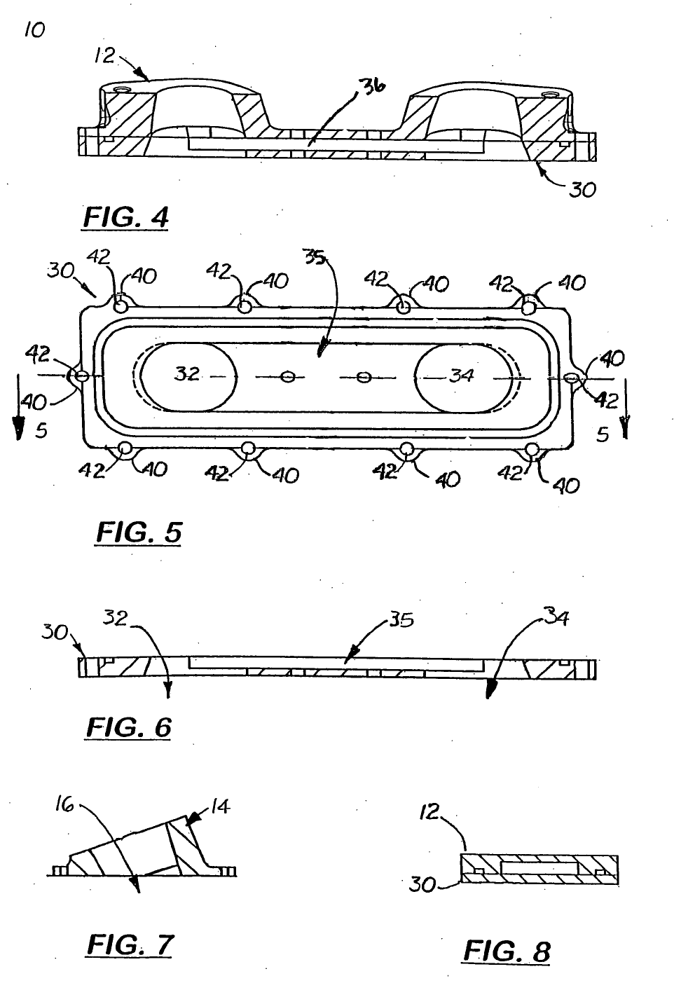

In the first embodiment, shown in FIGS. 1-8, the intake manifold 10 includes a plate body 11 made of an upper plate 12 and a lower plate 30. Formed on the upper plate 12 are two carburetor rest platforms 14, 20 formed on its opposite ends. Each platform 14, 20 includes a large central bore 16, 22, respectively, and two outer threaded bores 17, 18 and 23, 24, respectively. Formed around the upper plate 12 is a plurality of laterally extending ears 25 with smooth holes 26 formed therein.

Aligned and registered and stacked below the upper plate 12 is a complimentary shaped lower plate 30. The lower plate 30 also includes two cylinder bores 32, 34 formed on its opposite ends designed to extend over two adjacent cylinders formed on an engine. The area on the top surface of the lower plate 32 between the two cylinder bores 32, 34 is recessed thereby forming a wide, narrow cavity 36 between the two adjacent cylinder bores 32, 34. During assembly, the upper plate 12 and the lower plate 30 are aligned and stacked over engine block so that the bottom surface of the upper plate 12 closes over the cavity 35 to form a continuous cross flow air passageway 36 between the two cylinder bores 32, 34.

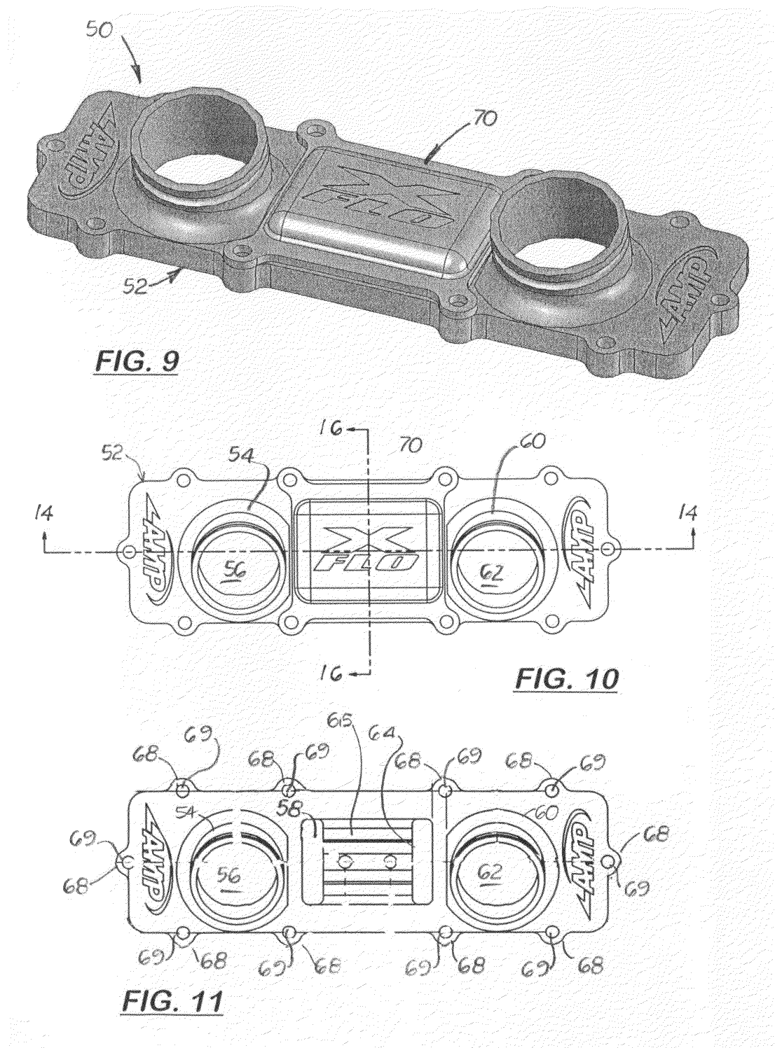

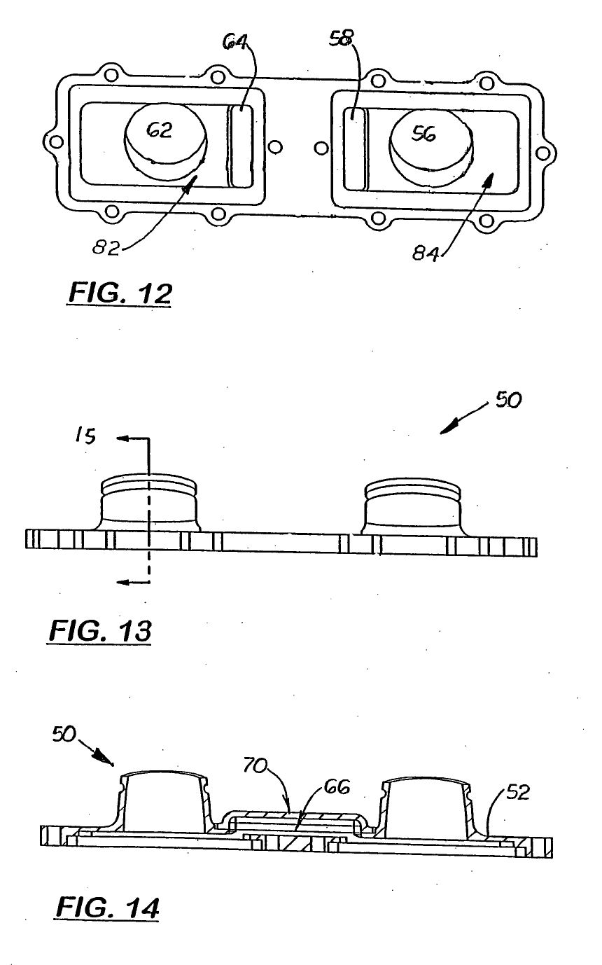

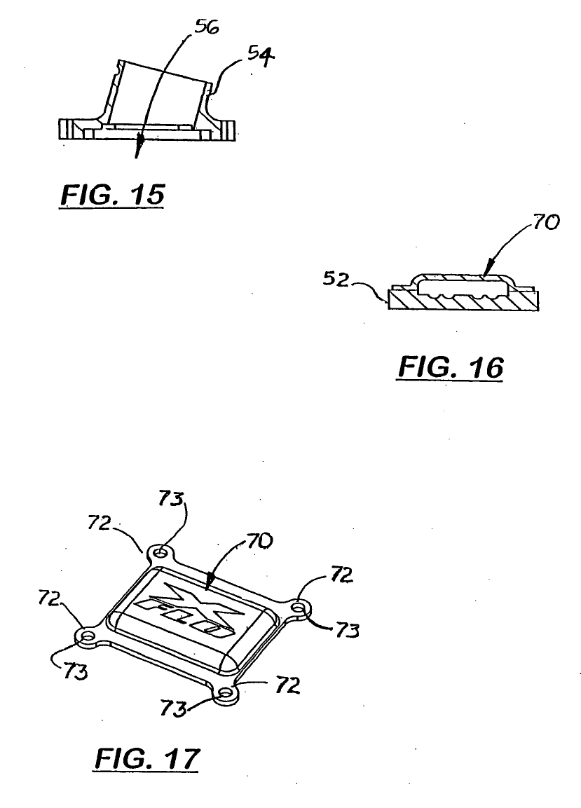

In a second embodiment shown in FIGS. 9-17, the plate body 11 is a single elongated plate 52 used in place of the upper plate 12 and the lower plate 30. The plate 52 also includes two carburetor rest platforms 54, 60 each with one circular cylinder bore 56, 62, respectively, designed to fit over two adjacent cylinders. In the preferred embodiment, a rectangular recessed cavity 65 is formed on the top surface of the plate 52 between the two rest platforms 54, 60. Formed on opposite ends of the recessed cavity 65 are two secondary ports 58, 64, In the preferred embodiment, the secondary ports 58, 64 are two transversely aligned elongated slots. The ports 58, 64, extend through the plate 52 and communicate with one of the elongated recessed cavities 82, 84 formed on the bottoms surface of the plate 52 and coaxially aligned around the two cylinder bores 56, 62.

Disposed over the top surface of the plate 52 is a removable cap 70. In the preferred embodiment, the cap 70 is cup-like in shape so that a continuous cross flow air passageway 66 is formed between the two cylinders. In the preferred embodiment, the cap 70 includes laterally extending ears 72 that include smooth bores 73 that are aligned and registered with smooth bores 69 formed on the four inside ears 68 on the plate 52.

During assembly, the plate 52 is aligned and stacked over engine block so that the two rest platforms 56, 62 are position over two adjacent cylinders. The cap 70 is then positioned over the recessed area 65. Ten threaded bolts (not shown) are then inserted through the smooth holes 69, 73 to attached the cap 70 and the plate 52 to the engine.

In both embodiments, a cross flow air passageway is formed between the two adjacent cylinders which acts to balance and improve performance.

Using one of the two described manifolds a method of improving the performance of a two stroke, side-by-side two cylinder engine is provided comprising the following steps″

a. selecting a manifold with at least two cylinder bores and a cross flow air passageway formed therebetween;

b. attaching said manifold so that said cylinder bores are located over two adjacent cylinders on a two cycle engine;

c. attaching a carburetor to each said cylinder bore; and,

d. operating said engine.

In compliance with the statute, the invention described herein has been described in language more or less specific as to structural features. It should be understood however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. A multiple carburetor intake manifold for a two-stroke engine, comprising:
a. an elongated plate body with at least two carburetor rest platforms each including a center bore, said center bores being aligned and registered over two adjacent cylinders on a two stroke engine; and,
b. a cross flow air passageway formed between said center bores to enable the fresh air and gasoline mixtures from the carburetors attached to said rest platforms to flow together and evenly distributed between adjacent cylinders.

2. The intake manifold, as recited in claim 1, further including said plate body being made up of an upper plate on which said rest platforms are formed on opposite ends, and a lower plate aligned and registered below said upper plate, said lower plate including a top surface with recessed cavity formed thereon so that when said upper plate and said lower plate are aligned and registered, a cross flow air passageway is between adjacent said center bores.

3. The intake manifold, as recited in claim 1, further including a plate body being a single plate on which said rest platforms are formed, said plate also including a bottom surface with two elongated recessed openings formed under said center bore, said plate includes two openings located between said rest platforms that extend through said plate and communicate with said recessed openings around each said center bores, and a top cap that attaches over said top surface of said plate and covers said two top openings thereby creating said cross flow air passageway.

4. A multiple carburetor intake manifold for a two-stroke engine, comprising:
a. an upper plate with two carburetor rest platforms each including a center bore, said center bores being aligned and registered over two adjacent cylinders on a two stroke engine;
b. a lower plate aligned and registered under said upper plate, said lower plate including two center bores that are aligned and registered under said center bores formed on said upper plate, and a top surface with a longitudinally aligned recessed area that communicates with said center bores, a cross flow air passageway being formed between said center bores when said upper plate and said lower plate are stacked and connected over two cylinders on an engine thereby enabling fresh air and gasoline mixtures from the carburetors attached to said rest platforms on said upper plate to flow together and evenly distributed to adjacent cylinders.

6. A method of improving the performance of a two stroke engine with at least two, side-by-side two cylinders comprising the following steps″
a. selecting a manifold with at least two carburetor rests each including a center bore to allow fresh air and gasoline mixture to flow into the cylinders located below, said manifold includes a ross flow air passageway formed between said center bores so that the fresh air and gasoline mixture delivered to adjacent cylinders may be evenly distributed between them;
b. attaching said manifold so that said cylinder bores are located over two adjacent cylinders on the two stoke engine;
c. attaching a carburetor to each said carburetor rest; and,
d. operating said engine.

7. The method as recited in claim 6, wherein said manifold includes a plate body that includes an upper plate on which said rest platforms are formed on opposite ends, and a lower plate aligned and registered below said upper plate, said lower plate including a top surface with recessed cavity formed thereon so that when said upper plate and said lower plate are aligned and registered, a cross flow air passageway is between adjacent said center bores.

8. The method as recited in claim 6, wherein said manifold includes a plate body made up of a single plate on which said rest platforms are formed on opposite ends, said plate includes a bottom surface with two elongated recessed openings formed under said center bore, said plate includes two openings located between said rest platforms that extend through said plate and communicate with said recessed openings around each said center bores, said intake manifold also include a top cap that attaches over said top surface of said plate and covers said two top openings thereby creating said cross flow air passageway.
